(19) United States
(12) Patent Application Publication
(10) Pub. No.: US 2026/0244994 A1
(43) Pub. Date: Aug. 20, 2026

(54) LOCAL ARTIFICIAL INTELLIGENCE (AI)/MACHINE LEARNING (ML) SERVICE FOR INTERNET OF THINGS (IOT) DEVICES

(71) Applicant: MaxLinear, Inc., Carlsbad, CA (US)

(72) Inventor: Saju Palayur, Poway, CA (US)

(73) Assignee: MaxLinear, Inc., Carlsbad, CA (US)

(21) Appl. No.: 19/542,577

(22) Filed: Feb. 17, 2026

Related U.S. Application Data
(60) Provisional application No. 63/759,129, filed on Feb. 15, 2025.

(51) Int. Cl. G06N 20/00

(52) U.S. Cl. CPC G06N 20/00

(57) ABSTRACT

A device may include a processing device. The processing device may receive, at the device from an internet of things (IoT) device, one or more of an artificial intelligence (AI) task or a machine learning (ML) task. The processing device may receive, at the device from an IoT device, input data related to the one or more of the AI task or the ML task. The processing device may perform, at the device, the one or more of the AI task or the ML task using the input data to generate output data. The processing device may send, from the device to the IoT device, the output data.

### RELATED APPLICATION

This application claims the benefit of U.S. Provisional Application No. 63/759,129, filed February 15, 2025, the disclosure of which is incorporated herein by reference in its entirety for all purposes.

The examples discussed in the present disclosure are related to local artificial intelligence (AI)/machine learning (ML) service for internet of things (IoT) devices.

### BACKGROUND

Unless otherwise indicated herein, the materials described herein are not prior art to the claims in the present application and are not admitted to be prior art by inclusion in this section.

Internet of things (IoT) devices may be sensors, processing ability, software and/or other technology that may connect and exchange data over various communication mediums. Because IoT devices have limited power and processing ability, enhanced methods of processing data may be useful.

The subject matter claimed in the present disclosure is not limited to examples that solve any disadvantages or that operate only in environments such as those described above. Rather, this background is only provided to illustrate one example technology area where some examples described in the present disclosure may be practiced.

### SUMMARY

In some examples, a device may include a processing device. The processing device may receive, at the device from an internet of things (IoT) device, one or more of an artificial intelligence (AI) task or a machine learning (ML) task. The processing device may receive, at the device from an IoT device, input data related to the one or more of the AI task or the ML task. The processing device may perform, at the device, the one or more of the AI task or the ML task using the input data to generate output data. The processing device may send, from the device to the IoT device, the output data. The device may be one or more of a gateway or an access point.

In some examples, a method may include receiving, at a device from an IoT device, one or more of an AI task or an ML task. The method may include receiving, at the device from the IoT device, input data related to the one or more of the AI task or the ML task. The method may include performing, at the device, the one or more of the AI task or the ML task using the input data to generate output data. The method may include sending, from the device to the IoT device, the output data.

In some examples, an IoT device may include a processing device. The processing device may identify, at the IoT device, one or more of an AI task or an ML task. The processing device may identify, at the IoT device, input data related to the one or more of the AI task or the ML task. The IoT device may include a transceiver that may send, from the IoT device to one or more of a gateway or an access point, the one or more of the AI task or the ML task. The transceiver may send, from the IoT device to one or more of the gateway or the access point, the input data related to the one or more of the AI task or the ML task. The transceiver may receive, from the one or more of the gateway or the access point, output data related to the one or more of the AI task or the ML task.

The objects and advantages of the examples will be realized and achieved at least by the elements, features, and combinations particularly pointed out in the claims.

Both the foregoing general description and the following detailed description are given as examples and are explanatory and are not restrictive of the invention, as claimed.

### BRIEF DESCRIPTION OF THE DRAWINGS

Examples will be described and explained with additional specificity and detail through the use of the accompanying drawings in which:

FIG. 1 illustrates an example block diagram for local artificial intelligence (AI)/machine learning (ML) service for internet of things (IoT).

FIG. 2 illustrates an example timing diagram for local AI/ML service for IoT.

FIG. 3 illustrates an example block diagram for local AI/ML service for IoT.

FIG. 4 illustrates an example block diagram for local AI/ML service for IoT.

FIG. 5 illustrates a process flow for local AI/ML service for IoT.

FIG. 6 illustrates a process flow for local AI/ML service for IoT.

FIG. 7 illustrates a block diagram of an example system operable to perform local AI/ML service for IoT.

FIG. 8 illustrates a diagrammatic representation of a machine in the example form of a computing device within which a set of instructions, for causing the machine to perform any one or more of the methods discussed herein, may be executed.

### DESCRIPTION

Internet of Things (IoT) devices, such as cameras, alarm sensors, energy monitors, and the like, may be present in homes but are typically low power and battery operated. Therefore, artificial intelligence (AI) and machine learning (ML) processing may be difficult to implement in IoT devices.

Therefore, to provide a secure, efficient, and cost-effective AI/ML service for IoT devices connected to a local network, centralized processing may be leveraged in a gateway. That is, a central gateway with AI/ML processing and long-term data storage may be used. The gateway may handle AI tasks for connected IoT devices, enabling intelligent decision-making.

Using a central gateway for AI/ML processing has several benefits. First, data remains within the home network, enhancing privacy and security by avoiding cloud dependency. Second, centralized processing may eliminate AI hardware in the IoT devices, reducing cost and increasing efficiency. Third, IoT devices may rely on the gateway, minimizing their battery consumption, which may reduce power consumption.

The central gateway may be implemented by connecting IoT devices via Wi-Fi or other wired/wireless connections, using minimal bandwidth. The gateway may collect, process, and offload storage or processing to the cloud or other local devices based on privacy settings. The gateway may be used for ambient-powered devices and ensures a self-contained, efficient home network.

Therefore, a central gateway may leverage existing home network infrastructure to provide robust AI/ML capabilities for IoT devices. It maximizes efficiency, enhances security, and offers a scalable solution for smart homes.

Although IoT devices are referenced throughout this written description, any device in the network that may use AI/ML processing may be envisioned. In one example, the AI/ML service may be multi-tenant (e.g., a shared service that may be used by numerous separate clients). Therefore, for purposes of this written description, a reference to IoT devices may additionally include references to other network devices for which AI/ML processing may be provided.

Examples of the present disclosure will be explained with reference to the accompanying drawings.

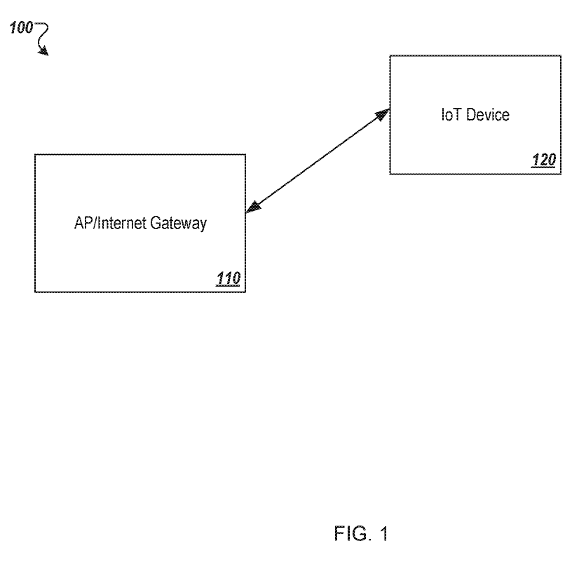

In some examples, FIG. 1 illustrates a block diagram 100 of communication between an AP/Internet Gateway 110 and an IoT device 120. The AP/Internet Gateway 110 may communicate with the IoT device 120 using any suitable communication medium. For example, the AP/Internet Gateway 110 may communicate with the IoT device 120 using a wireless wide area network (WWAN), a wireless local area network (WLAN), or a wireless personal area network (WPAN). A WWAN may include e.g., a cellular network such as 3G, 4G LTE, 5G, or the like. A WLAN may include e.g., a Wi-Fi® network. A WPAN may include e.g., Bluetooth, Bluetooth Low Energy, Zigbee, Z-Wave, or the like.

Modifications, additions, or omissions may be made to the components of FIG. 1 without departing from the scope of the present disclosure.

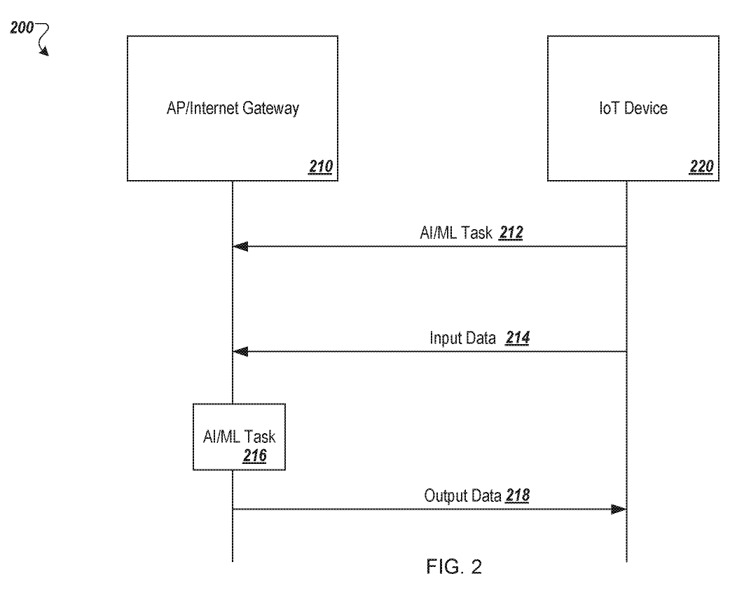

FIG. 2 illustrates a timing diagram for local AI/ML service for IoT. A device 210 (e.g., an access point or internet gateway) may include a processing device. The processing device may receive, at the device 210 from an IoT device 220, one or more of an artificial intelligence (AI) task or a machine learning (ML) task, as shown in operation 212. The processing device may receive, at the device 210 from an IoT device 220, input data related to the one or more of the AI task or the ML task, as shown in operation 214. The processing device may perform, at the device 210, the one or more of the AI task or the ML task using the input data to generate output data, as shown in operation 216. The processing device may send, from the device 210 to the IoT device 220, the output data, as shown in operation 218.

The device 210 may be one or more of a gateway or an access point. The processing device may store, at the device 210, one or more of the input data or the output data. The device 210 may include a transceiver that may communicate with the IoT device using one or more of a WWAN, a WLAN, or a WPAN. The processing device may advertise a service related to the one or more of the AI task or the ML task on a local area network.

The device 210 may perform the one or more of the AI task or the ML task without modifying the processing device when compared to a baseline processing device that does not perform the one or more of the AI task or the ML task. For example, the device 210 may include one or more instructions that when executed by the processing device, may perform the one or more of the AI task or the ML task even when the processing device has not been changed from a baseline processing device that does not have the functionality of performing the one or more of the AI task or the ML task. That is, the device 210 may perform the one or more of the AI task or the ML task without additional hardware when compared to a baseline device having a baseline processing device. The device 210 may perform the one or more of the AI task or the ML task based on a difference in software rather than a difference in hardware.

The IoT device 220 may include a processing device. The processing device may identify, at the IoT device 220, one or more of an artificial intelligence (AI) task or a machine learning (ML) task. The processing device may identify, at the IoT device 220, input data related to the one or more of the AI task or the ML task. The IoT device may include a transceiver. The transceiver may send, from the IoT device 220 to one or more of a gateway or an access point (e.g., device 210), the one or more of the AI task or the ML task. The transceiver may send, from the IoT device 220 to one or more of the gateway or the access point, the input data related to the one or more of the AI task or the ML task. The IoT device 220 may receive, from the one or more of the gateway or the access point, output data related to the one or more of the AI task or the ML task.

The IoT device 220 may have various functionality. The IoT device 220 may store, at the IoT device, the one or more of the input data or the output data. The IoT device 220 may identify, at the IoT device, a privacy setting for one or more of the input data or the output data. The IoT device 220 may have a transceiver that may communicate with the one or more of the gateway or the access point using one or more of a WWAN, a WLAN, or a WPAN. The IoT device may receive an advertisement related to the one or more of the AI task or the ML task on a local area network.

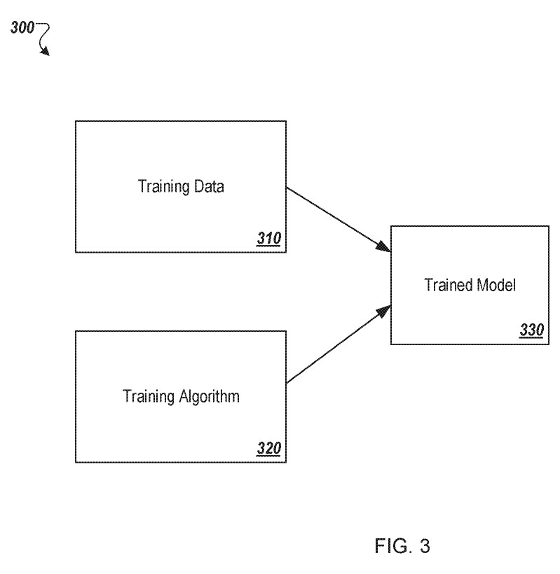

As illustrated in FIG. 3, a block diagram 300 is shown for generating a trained model. A processing device may train, at the device, a model based on training data 310 and a selected training algorithm 320 to generate a trained model 330. The processing device may perform, at the device, the one or more of the AI task or the ML task using the trained model 330.

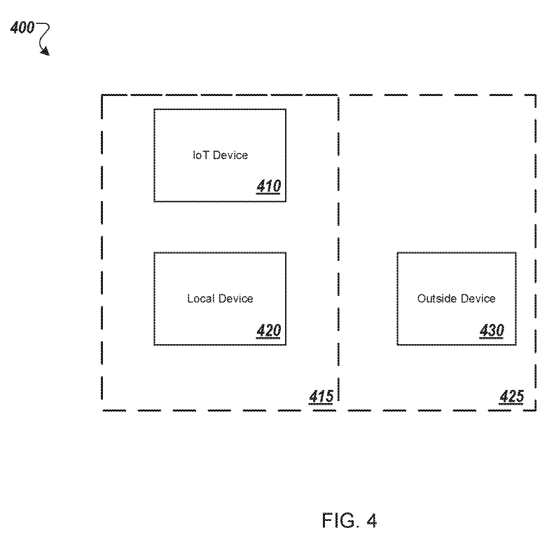

FIG. 4 illustrates privacy settings for a device and IoT devices. A processing device at the device (e.g., local device 420) may identify, at the device, a privacy setting for one or more of the input data or the output data. The processing device may maintain the one or more of the input data or the output data in a local network 415 based on the privacy setting (e.g., when the privacy setting is more constrained). The processing device may send, from the device to another device (e.g., outside device 430 in a non-local network 425), one or more of the input data or the output data based on the privacy setting (e.g., when the privacy setting may be more expansive).

A processing device at an IoT device 410 may identify, at the IoT device, a privacy setting for one or more of the input data or the output data. The processing device may maintain the one or more of the input data or the output data in a local network 415 based on the privacy setting. The processing device may send, from the IoT device to another device (e.g., outside device 430 in a non-local network 425), one or more of the input data or the output data based on the privacy setting.

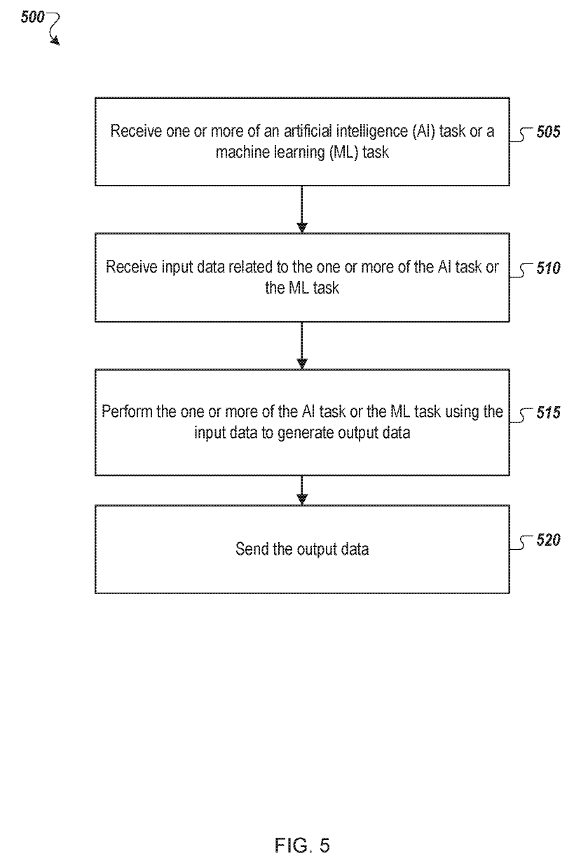

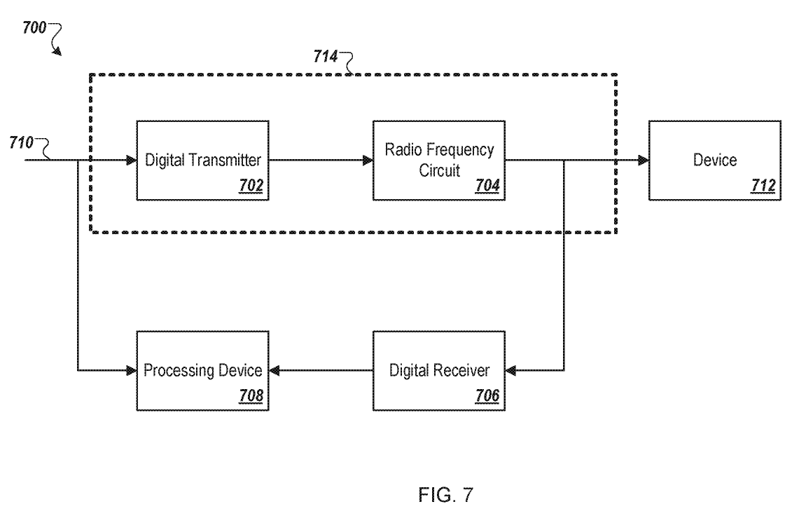

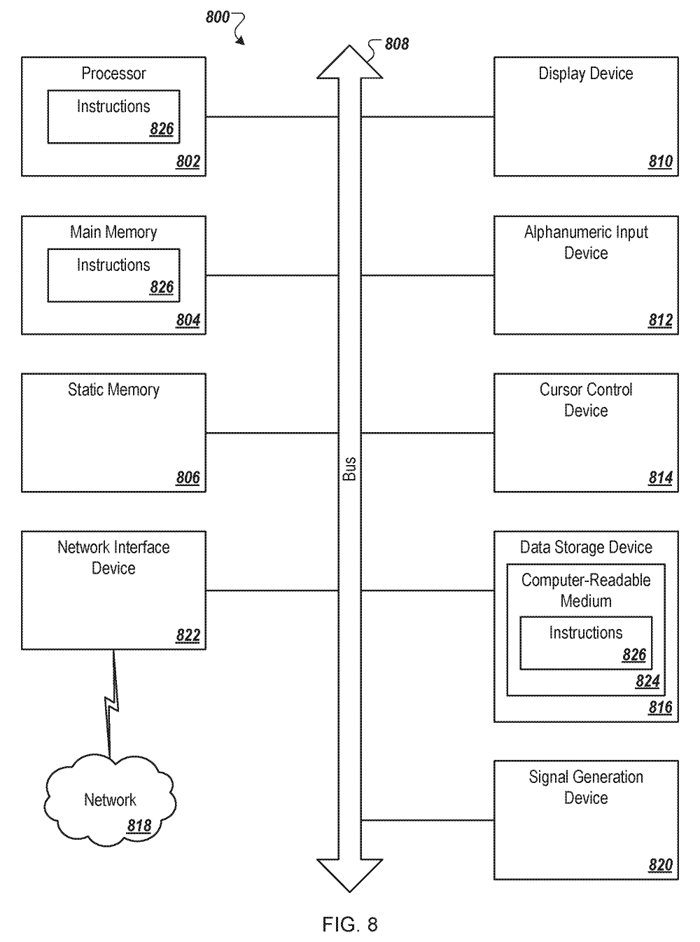

FIG. 5 illustrates a process flow of an example method 500 of local AI/ML service for IoT, in accordance with at least one example described in the present disclosure. The method 500 may be arranged in accordance with at least one example described in the present disclosure. The method 500 may be performed by processing logic that may include hardware (circuitry, dedicated logic, etc.), software (such as is run on a computer system or a dedicated machine), or a combination of both, which processing logic may be included in the processing device 802 of FIG. 8, the communication system 700 of FIG. 7, or another device, combination of devices, or systems.

The method 500 may begin at block 505 where the processing logic may receive, at a device from an IoT device, one or more of an AI task or a ML task.

In block 510, the processing logic may receive, at the device from the IoT device, input data related to the one or more of the AI task or the ML task.

In block 515, the processing logic may perform, at the device, the one or more of the AI task or the ML task using the input data to generate output data.

In block 520, the processing logic may send, from the device to the IoT device, the output data.

The processing logic may train, at the device, a model based on training data and a selected training algorithm to generate a trained model; and/or perform, at the device, the one or more of the AI task or the ML task using the trained model.

The processing logic may store, at the device, one or more of the input data or the output data. The processing logic may identify, at the device, a privacy setting for one or more of the input data or the output data. The processing logic may maintain the one or more of the input data or the output data in a local network based on the privacy setting. The processing logic may send, from the device to another device, one or more of the input data or the output data based on the privacy setting.

Modifications, additions, or omissions may be made to the method 500 without departing from the scope of the present disclosure. For example, in some examples, the method 500 may include any number of other components that may not be explicitly illustrated or described.

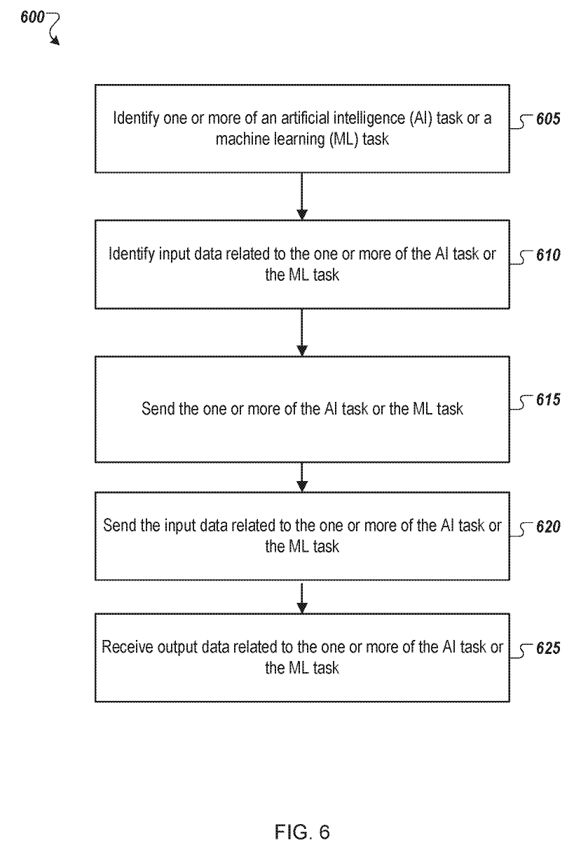

FIG. 6 illustrates a process flow of an example method 600 of local AI/ML service for IoT, in accordance with at least one example described in the present disclosure. The method 600 may be arranged in accordance with at least one example described in the present disclosure.

The method 600 may be performed by processing logic that may include hardware (circuitry, dedicated logic, etc.), software (such as is run on a computer system or a dedicated machine), or a combination of both, which processing logic may be included in the processing device 802 of FIG. 8, the communication system 700 of FIG. 7, or another device, combination of devices, or systems.

The method 600 may begin at block 605 where the processing logic may identify, at the IoT device, one or more of an artificial intelligence (AI) task or a machine learning (ML) task.

At block 610, the processing logic may identify, at the IoT device, input data related to the one or more of the AI task or the ML task.

At block 615, the processing logic may send, from the IoT device to one or more of a gateway or an access point, the one or more of the AI task or the ML task.

At block 620, the processing logic may send, from the IoT device to one or more of the gateway or the access point, the input data related to the one or more of the AI task or the ML task.

At block 625, the processing logic may receive, from the one or more of the gateway or the access point, output data related to the one or more of the AI task or the ML task.

Modifications, additions, or omissions may be made to the method 600 without departing from the scope of the present disclosure. For example, in some examples, the method 600 may include any number of other components that may not be explicitly illustrated or described.

For simplicity of explanation, methods and/or process flows described herein are depicted and described as a series of acts. However, acts in accordance with this disclosure may occur in various orders and/or concurrently, and with other acts not presented and described herein. Further, not all illustrated acts may be used to implement the methods in accordance with the disclosed subject matter. In addition, those skilled in the art will understand and appreciate that the methods may alternatively be represented as a series of interrelated states via a state diagram or events. Additionally, the methods disclosed in this specification are capable of being stored on an article of manufacture, such as a non-transitory computer-readable medium, to facilitate transporting and transferring such methods to computing devices. The term article of manufacture, as used herein, is intended to encompass a computer program accessible from any computer-readable device or storage media. Although illustrated as discrete blocks, various blocks may be divided into additional blocks, combined into fewer blocks, or eliminated, depending on the desired implementation.

FIG. 7 illustrates a block diagram of an example communication system 700 for local AI/ML service for IoT, in accordance with at least one example described in the present disclosure. The communication system 700 may include a digital transmitter 702, a radio frequency circuit 704, a device 712, a digital receiver 706, and a processing device 708. The digital transmitter 702 and the processing device 708 may receive a baseband signal via connection 710. A transceiver 714 may include the digital transmitter 702 and the radio frequency circuit 704.

In some examples, the communication system 700 may include a system of devices that may communicate with one another via a wired or wireline connection. For example, a wired connection in the communication system 700 may include one or more Ethernet cables, one or more fiber-optic cables, and/or other similar wired communication mediums. Alternatively, or additionally, the communication system 700 may include a system of devices that may communicate via one or more wireless connections. For example, the communication system 700 may include one or more devices that may transmit and/or receive radio waves, microwaves, ultrasonic waves, optical waves, electromagnetic induction, and/or similar wireless communications. Alternatively, or additionally, the communication system 700 may include combinations of wireless and/or wired connections. In these and other examples, the communication system 700 may include one or more devices that may obtain a baseband signal, perform one or more operations to the baseband signal to generate a modified baseband signal, and transmit the modified baseband signal, such as to one or more loads.

In some examples, the communication system 700 may include one or more communication channels that may communicatively couple systems and/or devices included in the communication system 700. For example, the transceiver 714 may be communicatively coupled to the device 712.

In some examples, the transceiver 714 may obtain a baseband signal. For example, as described herein, the transceiver 714 may generate a baseband signal and/or receive a baseband signal from another device. In some examples, the transceiver 714 may transmit the baseband signal. For example, upon obtaining the baseband signal, the transceiver 714 may transmit the baseband signal to a separate device, such as the device 712. Alternatively, or additionally, the transceiver 714 may modify, condition, and/or transform the baseband signal in advance of transmitting the baseband signal. For example, the transceiver 714 may include a quadrature up-converter and/or a digital to analog converter (DAC) that may modify the baseband signal. Alternatively, or additionally, the transceiver 714 may include a direct radio frequency (RF) sampling converter that may modify the baseband signal.

In some examples, the digital transmitter 702 may obtain a baseband signal via connection 710. In some examples, the digital transmitter 702 may up-convert the baseband signal. For example, the digital transmitter 702 may include a quadrature up-converter to apply to the baseband signal. In some examples, the digital transmitter 702 may include an integrated digital to analog converter (DAC). The DAC may convert the baseband signal to an analog signal, or a continuous time signal. In some examples, the DAC architecture may include a direct RF sampling DAC. In some examples, the DAC may be a separate element from the digital transmitter 702.

In some examples, the transceiver 714 may include one or more subcomponents that may be used in preparing the baseband signal and/or transmitting the baseband signal. For example, the transceiver 714 may include an RF front end (e.g., in a wireless environment) which may include a power amplifier (PA), a digital transmitter (e.g., 702), a digital front end, an Institute of Electrical and Electronics Engineers (IEEE) 1588v2 device, a Long-Term Evolution (LTE) physical layer (L-PHY), an (S-plane) device, a management plane (M-plane) device, an Ethernet media access control (MAC)/personal communications service (PCS), a resource controller/scheduler, or the like. In some examples, a radio (e.g., a radio frequency circuit 704) of the transceiver 714 may be synchronized with the resource controller via the S-plane device, which may contribute to high-accuracy timing with respect to a reference clock.

In some examples, the transceiver 714 may obtain the baseband signal for transmission. For example, the transceiver 714 may receive the baseband signal from a separate device, such as a signal generator. For example, the baseband signal may come from a transducer that may convert a variable into an electrical signal, such as an audio signal output of a microphone picking up a speaker's voice. Alternatively, or additionally, the transceiver 714 may generate a baseband signal for transmission. In these and other examples, the transceiver 714 may transmit the baseband signal to another device, such as the device 712.

In some examples, the device 712 may receive a transmission from the transceiver 714. For example, the transceiver 714 may transmit a baseband signal to the device 712.

In some examples, the radio frequency circuit 704 may transmit the digital signal received from the digital transmitter 702. In some examples, the radio frequency circuit 704 may transmit the digital signal to the device 712 and/or the digital receiver 706. In some examples, the digital receiver 706 may receive a digital signal from the RF circuit and/or send a digital signal to the processing device 708.

In some examples, the processing device 708 may be a standalone device or system, as illustrated. Alternatively, or additionally, the processing device 708 may be a component of another device and/or system. For example, in some examples, the processing device 708 may be included in the transceiver 714. In instances in which the processing device 708 is a standalone device or system, the processing device 708 may communicate with additional devices and/or systems remote from the processing device 708, such as the transceiver 714 and/or the device 712. For example, the processing device 708 may send and/or receive transmissions from the transceiver 714 and/or the device 712. In some examples, the processing device 708 may be combined with other elements of the communication system 700.

FIG. 8 illustrates a diagrammatic representation of a machine in the example form of a computing device 800 within which a set of instructions, for causing the machine to perform any one or more of the methods discussed herein, may be executed. The computing device 800 may include a rackmount server, a router computer, a server computer, a mainframe computer, a laptop computer, a tablet computer, a desktop computer, or any computing device with at least one processor, etc., within which a set of instructions, for causing the machine to perform any one or more of the methods discussed herein, may be executed. In alternative examples, the machine may be connected (e.g., networked) to other machines in a local area network (LAN), an intranet, an extranet, or the Internet. The machine may operate in the capacity of a server machine in client-server network environment. Further, while only a single machine is illustrated, the term “machine” may also include any collection of machines that individually or jointly execute a set (or multiple sets) of instructions to perform any one or more of the methods discussed herein.

The example computing device 800 includes a processing device (e.g., a processor) 802, a main memory 804 (e.g., read-only memory (ROM), flash memory, dynamic random access memory (DRAM) such as synchronous DRAM (SDRAM)), a static memory 806 (e.g., flash memory, static random access memory (SRAM)) and a data storage device 816, which communicate with each other via a bus 808.

Processing device 802 represents one or more general-purpose processing devices such as a microprocessor, central processing unit, or the like. More particularly, the processing device 802 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 802 may also include one or more special-purpose processing devices such as an application specific integrated circuit (ASIC), a field programmable gate array (FPGA), a digital signal processor (DSP), network processor, or the like. The processing device 802 is configured to execute instructions 826 for performing the operations and steps discussed herein.

The computing device 800 may further include a network interface device 822 which may communicate with a network 818. The computing device 800 also may include a display device 810 (e.g., a liquid crystal display (LCD) or a cathode ray tube (CRT)), an alphanumeric input device 812 (e.g., a keyboard), a cursor control device 814 (e.g., a mouse) and a signal generation device 820 (e.g., a speaker). In at least one example, the display device 810, the alphanumeric input device 812, and the cursor control device 814 may be combined into a single component or device (e.g., an LCD touch screen).

The data storage device 816 may include a computer-readable storage medium 824 on which is stored one or more sets of instructions 826 embodying any one or more of the methods or functions described herein. The instructions 826 may also reside, completely or at least partially, within the main memory 804 and/or within the processing device 802 during execution thereof by the computing device 800, the main memory 804 and the processing device 802 also constituting computer-readable media. The instructions may further be transmitted or received over a network 818 via the network interface device 822.

While the computer-readable storage medium 824 is shown in an example to be a single medium, the term “computer-readable storage medium” may include a single medium or multiple media (e.g., a centralized or distributed database and/or associated caches and servers) that store the one or more sets of instructions. The term “computer-readable storage medium” may also include any medium that is capable of storing, encoding or carrying a set of instructions for execution by the machine and that cause the machine to perform any one or more of the methods of the present disclosure. The term “computer-readable storage medium” may accordingly be taken to include, but not be limited to, solid-state memories, optical media, and magnetic media.

In some examples, the different components, modules, engines, and services described herein may be implemented as objects or processes that execute on a computing system (e.g., as separate threads). While some of the systems and methods described herein are generally described as being implemented in software (stored on and/or executed by hardware), specific hardware implementations or a combination of software and specific hardware implementations are also possible and contemplated.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to examples containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absent a showing that the terms “first,” “second,” “third,” etc., connote a specific order, these terms should not be understood to connote a specific order. Furthermore, absent a showing that the terms first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the invention and the concepts contributed by the inventor to furthering the art, and are to be construed as being without limitation to such specifically recited examples and conditions. Although examples of the present disclosure have been described in detail, it should be understood that the various changes, substitutions, and alterations could be made hereto without departing from the spirit and scope of the present disclosure.

What is claimed is:

1. A device, comprising:
a processing device operable to:
receive, at the device from an internet of things (IoT) device, one or more of an artificial intelligence (AI) task or a machine learning (ML) task;
receive, at the device from an IoT device, input data related to the one or more of the AI task or the ML task;
perform, at the device, the one or more of the AI task or the ML task using the input data to generate output data; and
send, from the device to the IoT device, the output data,
wherein the device is one or more of a gateway or an access point.

2. The device of claim 1, wherein the processing device is operable to perform, at the device, the one or more of the AI task or the ML task without modifying the processing device when compared to a baseline processing device that does not perform the one or more of the AI task or the ML task.

3. The device of claim 1, wherein the processing device is further operable to:
train, at the device, a model based on training data and a selected training algorithm to generate a trained model; and
perform, at the device, the one or more of the AI task or the ML task using the trained model.

4. The device of claim 1, wherein the processing device is further operable to store, at the device, one or more of the input data or the output data.

5. The device of claim 1, wherein the processing device is further operable to:
identify, at the device, a privacy setting for one or more of the input data or the output data.

6. The device of claim 5, wherein the processing device is further operable to maintain the one or more of the input data or the output data in a local network based on the privacy setting.

7. The device of claim 5, wherein the processing device is further operable to send, from the device to another device, one or more of the input data or the output data based on the privacy setting.

8. The device of claim 1, further comprising a transceiver operable to communicate with the IoT device using one or more of a wireless wide area network (WWAN), a wireless local area network (WLAN), or a wireless personal area network (WPAN).

9. The device of claim 1, wherein the processing device is further operable to advertise a service related to the one or more of the AI task or the ML task on a local area network.

10. A method, comprising:
receiving, at a device from an internet of things (IoT) device, one or more of an artificial intelligence (AI) task or a machine learning (ML) task;
receiving, at the device from the IoT device, input data related to the one or more of the AI task or the ML task;
performing, at the device, the one or more of the AI task or the ML task using the input data to generate output data; and
sending, from the device to the IoT device, the output data.

11. The method of claim 10, further comprising:
training, at the device, a model based on training data and a selected training algorithm to generate a trained model; and
performing, at the device, the one or more of the AI task or the ML task using the trained model.

12. The method of claim 10, further comprising:
storing, at the device, one or more of the input data or the output data.

13. The method of claim 10, further comprising:
identifying, at the device, a privacy setting for one or more of the input data or the output data;
maintaining the one or more of the input data or the output data in a local network based on the privacy setting; and
sending, from the device to another device, one or more of the input data or the output data based on the privacy setting.

14. An internet of things (IoT) device, comprising:
a processing device operable to:
identify, at the IoT device, one or more of an artificial intelligence (AI) task or a machine learning (ML) task; and
identify, at the IoT device, input data related to the one or more of the AI task or the ML task; and
a transceiver operable to:
send, from the IoT device to one or more of a gateway or an access point, the one or more of the AI task or the ML task;
send, from the IoT device to one or more of the gateway or the access point, the input data related to the one or more of the AI task or the ML task; and
receive, from the one or more of the gateway or the access point, output data related to the one or more of the AI task or the ML task.

15. The IoT device of claim 14, wherein the processing device is further operable to store, at the IoT device, the one or more of the input data or the output data.

16. The IoT device of claim 14, wherein the processing device is further operable to identify, at the IoT device, a privacy setting for one or more of the input data or the output data.

17. The IoT device of claim 16, wherein the processing device is further operable to maintain the one or more of the input data or the output data in a local network based on the privacy setting.

18. The IoT device of claim 16, wherein the processing device is further operable to send, from the IoT device to another device, one or more of the input data or the output data based on the privacy setting.

19. The IoT device of claim 14, wherein the transceiver is operable to communicate with the one or more of the gateway or the access point using one or more of a wireless wide area network (WWAN), a wireless local area network (WLAN), or a wireless personal area network (WPAN).

20. The IoT device of claim 14, wherein the processing device is further operable to receive an advertisement related to the one or more of the AI task or the ML task on a local area network.
